(19) United States
(12) Patent Application Publication
(10) Pub. No.: US 2016/0267579 A1
(43) Pub. Date: Sep. 15, 2016

(54) RENTAL SYSTEM AND RENTAL MANAGEMENT METHOD

(71) Applicant: Panasonic Intellectual Property Management Co., Ltd., Osaka (JP)

(72) Inventor: SHOICHI TOYA, Hyogo (JP)

(21) Appl. No.: 15/049,054

(22) Filed: Feb. 20, 2016

(30) Foreign Application Priority Data
Mar. 9, 2015 (JP) 2015-046338

(51) Int. Cl. G06Q 30/06; G06F 3/14; H02J 7/00

(52) U.S. Cl. CPC G06Q 30/0645; H02J 7/0021; H02J 7/0042; G06F 3/14

(57) ABSTRACT

A rental system includes a first acquirer that acquires first identification information, which is identification information of a user, from a storage device in which the first identification information is stored; a second acquirer that acquires second identification information, which is identification information of a first battery pack, which is a battery pack for rent, from a storage provided in the first battery pack; control circuitry that associates the first identification information acquired by the first acquirer and the second identification information acquired by the second acquirer with each other when the first battery pack is rented to the user; and a storage in which the first identification information and the second identification information are stored in association with each other.

### BACKGROUND

1. Technical Field

The present disclosure relates to a battery pack rental system and the like.

2. Description of the Related Art

Japanese Unexamined Patent Application Publication No. 2011-118638 describes a technique concerning a battery pack rental system and the like. Specifically, Japanese Unexamined Patent Application Publication No. 2011-118638 describes a battery rental system for offering a battery in accordance with a user's request.

However, unless battery packs for rent are properly managed, it is difficult to rent a battery pack to a user and collect a battery pack from a user.

### SUMMARY

One non-limiting and exemplary embodiment provides a rental system and the like that can properly manage a battery pack for rent.

In one general aspect, the techniques disclosed here feature a rental system including: a first acquirer that acquires first identification information, which is identification information of a user, from a storage device in which the first identification information is stored; a second acquirer that acquires second identification information, which is identification information of a first battery pack, which is a battery pack for rent, from a storage provided in the first battery pack; control circuitry that associates the first identification information acquired by the first acquirer and the second identification information acquired by the second acquirer with each other when the first battery pack is rented to the user; and a storage in which the first identification information and the second identification information are stored in association with each other.

The rental system according to one aspect of the present disclosure can properly manage a battery pack for rent.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating a configuration of a rental system according to an embodiment;

FIG. 2 is a schematic view illustrating a first example of application of the rental system according to the embodiment;

FIG. 3 is a schematic view illustrating a second example of application of the rental system according to the embodiment;

FIG. 4 is a block diagram illustrating configurations of an inspection device and the like according to the embodiment;

FIG. 5 is a diagram illustrating rent information according to the embodiment;

FIG. 6 is a diagram illustrating information indicative of a degree of degradation according to the embodiment;

FIG. 7 is a flow chart illustrating member registration processing according to the embodiment;

FIG. 8 is a flow chart illustrating rental processing according to the embodiment;

FIG. 9 is a flow chart illustrating return processing according to the embodiment;

FIG. 10 is a flow chart illustrating exchange processing according to the embodiment; and

FIG. 11 is a flow chart illustrating a modification of the exchange processing according to the embodiment.

### DETAILED DESCRIPTION

### Underlying Knowledge Forming Basis of the Present Disclosure

The inventor of the present invention found the following problems concerning a battery pack rental system described in Description of the Related Art.

Although it is difficult to distinguish a plurality of battery packs of the same type on the basis of appearances thereof, these battery packs are sometimes different from one another in terms of the degree of degradation (degradation level) because of differences in the number of times of charge and the like. That is, even in a case where a plurality of battery packs look the same, there is a possibility that these battery packs markedly differ from one another in terms of quality. In a case where battery packs having such a characteristic are rented to a user, the battery packs need be properly distinguished from one another.

In view of this, a rental system according to a first aspect of the present disclosure is a rental system including: a first acquirer that acquires first identification information, which is identification information of a user, from a storage device in which the first identification information is stored; a second acquirer that acquires second identification information, which is identification information of a first battery pack, which is a battery pack for rent, from a storage provided in the first battery pack; control circuitry that associates the first identification information acquired by the first acquirer and the second identification information acquired by the second acquirer with each other when the first battery pack is rented to the user; and a storage in which the first identification information and the second identification information are stored in association with each other.

This allows the rental system to properly manage a user and a battery pack rented to the user in association with each other.

In the rental system according to the first aspect, a rental system according to a second aspect of the present disclosure may be arranged such that the second acquirer further acquires information indicative of a first degree of degradation, which is a degree of degradation of the first battery pack; and the information indicative of the first degree of degradation acquired by the second acquirer is further stored in the storage included in the rental system.

This allows the rental system to properly manage a degree of degradation of a battery pack for rent.

In the rental system according to the second aspect, a rental system according to a third aspect of the present disclosure may be arranged to further include an output unit that acquires the information indicative of the first degree of degradation from the storage included in the rental system and outputs the information indicative of the first degree of degradation when the first battery pack is rented to the user.

This allows the rental system to notify a user of a degree of degradation of a battery pack when the battery pack is rented to the user.

In the rental system according to the third aspect, a rental system according to a fourth aspect of the present disclosure may be arranged such that the output unit outputs the information indicative of the first degree of degradation on a display screen.

This allows the rental system to visually notify a user of a degree of degradation of a battery pack when the battery pack is rented to the user.

In the rental system according to any one of the first through fourth aspects, a rental system according to a fifth aspect of the present disclosure may be arranged such that the second acquirer further acquires third identification information, which is identification information of a second battery pack, which is a battery pack owned by the user, from a storage provided in the second battery pack; the control circuitry further associates the first identification information acquired by the first acquirer and the third identification information acquired by the second acquirer with each other when the first battery pack is rented to the user by exchange between the first battery pack and the second battery pack; and the first identification information and the third identification information are further stored in association with each other in the storage included in the rental system.

This allows the rental system to properly manage a user and a battery pack owned by the user in association with each other.

In the rental system according to the fifth aspect, a rental system according to a sixth aspect of the present disclosure may be arranged to further include a notifier that notifies the user of completion of charge upon completion of charge of the second battery pack.

This allows the rental system to notify a user of a timing appropriate for reception of a battery pack owned by the user.

In the rental system according to any one of the first through sixth aspects, a rental system according to a seventh aspect of the present disclosure may be arranged such that when the first battery pack is returned from the user, the control circuitry compares the first identification information acquired by the first acquirer and the second identification information acquired by the second acquirer with the first identification information and the second identification information that are associated with each other by the control circuitry and stored in the storage included in the rental system when the first battery pack is rented to the user.

This allows the rental system to confirm that a battery pack rented to a user is the same as a battery pack returned from the user.

In the rental system according to any one of the first through seventh aspects, a rental system according to an eighth aspect of the present disclosure may be arranged such that the control circuitry performs processing for imposing a penalty on the user in a case where the first battery pack is returned from the user past a return deadline.

This allows the rental system to impose a penalty on a user in accordance with an excess period elapsed from a return deadline of a battery pack.

In the rental system according to any one of the second through fourth aspects, a rental system according to a ninth aspect of the present disclosure may be arranged such that the control circuitry performs processing for imposing a penalty on the user in a case where it is determined that the first degree of degradation acquired when the first battery pack is returned from the user is higher by a predetermined value than that acquired when the first battery pack is rented to the user on the basis of the information indicative of the first degree of degradation acquired by the second acquirer when the first battery pack is returned from the user and the information indicative of the first degree of degradation stored in the storage included in the rental system when the first battery pack is rented to the user.

This allows the rental system to impose a penalty on a user in accordance with excessive degradation of a battery pack returned from a user.

In the rental system according to any one of the first through ninth aspects, a rental system according to a tenth aspect of the present disclosure may be arranged such that the second acquirer further acquires information indicative of a state of the first battery pack when the first battery pack is returned from the user; and the control circuitry performs processing for imposing a penalty on the user in a case where it is determined that the first battery pack has abnormality in accordance with the information indicative of the state of the first battery pack.

This allows the rental system to impose a penalty in accordance with abnormality of a battery pack returned from a user.

In the rental system according to any one of the second through fourth aspects, a rental system according to an eleventh aspect of the present disclosure may be arranged such that the second acquirer further acquires information indicative of a second degree of degradation, which is a degree of degradation of a second battery pack, which is a battery pack brought by the user; and the control circuitry selects, as the first battery pack rented to the user, a battery pack whose degree of degradation is equal to or lower than the second degree of degradation from among a plurality of battery packs for rent when the first battery pack is rented to the user by exchange between the first battery pack and the second battery pack.

This allows the rental system to select, as a battery pack rented to a user, a battery pack whose quality is equivalent to or greater than that of a battery pack brought by the user.

In the rental system according to any one of the first through eleventh aspects, a rental system according to a twelfth aspect of the present disclosure may be arranged to further include: a connector that is electrically connected to the first battery pack; and a discharger that discharges the first battery pack connected to the connector, the connector being integral with the second acquirer, and the second acquirer being located so as to be able to acquire the second identification information from the storage provided in the first battery pack when the first battery pack and the connector are connected to each other.

This allows the rental system to acquire identification information of a battery pack while discharging the battery pack.

In the rental system according to the twelfth aspect, a rental system according to a thirteenth aspect of the present disclosure may be arranged to further include a first inspector that inspects whether or not the first battery pack is discharged by using the discharger when the first battery pack and the discharger are electrically connected to each other via the connector.

This allows the rental system to inspect whether or not a battery pack is properly discharged at the time of rent and/or at the time of return.

In the rental system according to the thirteenth aspect, a rental system according to a fourteenth aspect of the present disclosure may be arranged to further include: a charger that charges the first battery pack connected to the connector; and a second inspector that inspects whether or not the first battery pack is charged by using the charger when the first battery pack and the charger are electrically connected to each other via the connector.

This allows the rental system to inspect whether or not a battery pack is properly charged at the time of rent and/or at the time of return.

In the rental system according to any one of the first through tenth aspects, a rental system according to a fifteenth aspect of the present disclosure may be arranged to further include: a housing in which a plurality of battery packs including the first battery pack are contained; a connector that is provided in the housing and is electrically connected to each of the plurality of battery packs; and a charger that charges the plurality of battery packs connected to the connector by using electric power from an external power supply; the second acquirer being located so as to be able to acquire identification information of each of the plurality of battery packs from a plurality of storages provided in the plurality of battery packs connected to the connector in the housing.

This allows the rental system to acquire identification information of each of a plurality of battery packs while charging the plurality of battery packs in a housing in which the plurality of battery packs are contained.

It should be noted that general or specific embodiments may be implemented as a system, a method, an integrated circuit, a computer program, a non-transitory computer-readable storage medium such as a CD-ROM, or any selective combination thereof.

In particular, a rental management method according to a sixteenth aspect of the present disclosure is a rental management method performed by a rental system, including: acquiring first identification information, which is identification information of a user, from a storage device in which the first identification information is stored; acquiring second identification information, which is identification information of a first battery pack, which is a battery pack for rent, from a storage provided in the first battery pack; and causing the acquired first identification information and the acquired second identification information to be stored in a storage included in the rental system when the first battery pack is rented to the user.

An embodiment is specifically described below with reference to the drawings. Note that the embodiment described below illustrates a general or specific example. Numerical values, shapes, materials, constituent elements, the way in which the constituent elements are disposed and connected, steps, the order of steps, and the like described in the embodiment below are examples and do not limit the present disclosure. Among the constituent elements in the embodiment below, constituent elements that are not described in the independent claims that show highest concepts are described as optional constituent elements.

Ordinal numbers such as “first”, “second”, and “third” may be added to the constituent elements as appropriate.

### Embodiment

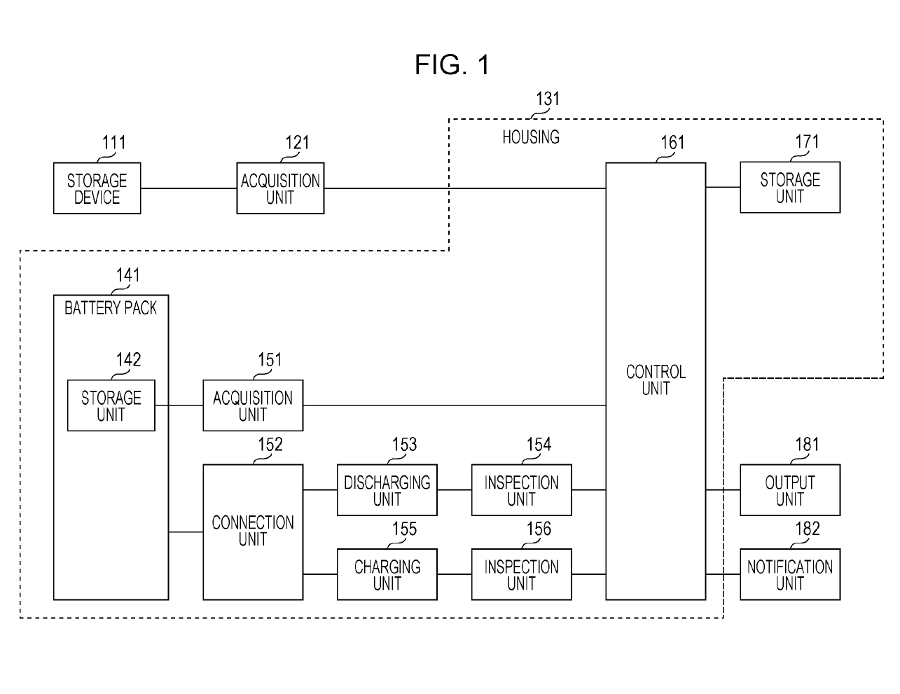

FIG. 1 is a block diagram illustrating a configuration of a rental system according to the present embodiment. Basic constituent elements of the rental system illustrated in FIG. 1 are acquisition units 121 and 151, a control unit 161, and a storage unit 171. Other constituent elements need not be included in the rental system.

A storage device 111 is an example of a storage device of the present disclosure and is a storage device in which identification information of a user is stored. For example, the storage device 111 may be an IC (Integrated Circuit) card in which identification information of a user is stored or may be a storage unit of a mobile terminal in which an identification number of a user is stored. An individual identification number stored in a storage unit of a mobile terminal may be used as an identification number of a user. That is, the identification number is not limited to a specific one, provided that the identification number can be used as an identification number of a user. The user is, for example, an individual, but is not limited to this. The user may be an organization such as a corporation. Note that identification information of a user is hereinafter sometimes referred to as user identification information.

The acquisition unit 121 is an example of a first acquirer of the present disclosure and is an acquisition unit that acquires user identification information from the storage device 111. For example, the acquisition unit 121 is a card reader that acquires user identification information from an IC card.

A housing 131 is an example of a housing of the present disclosure and is a housing in which a battery pack 141 is contained. A plurality of battery packs 141 may be contained in the housing 131. The housing 131 may include the acquisition unit 151, a connection unit 152, a discharging unit 153, a charging unit 155, inspection units 154 and 156, the control unit 161, and the storage unit 171. The housing 131 may further include an output unit 181 and a notification unit 182.

The battery pack 141 is an example of a battery pack (a first battery pack and a second battery pack) of the present disclosure and is a battery pack that can be charged and discharged. The battery pack 141 includes a storage unit 142.

A plurality of battery packs 141 may be used in the rental system. For example, a battery pack 141 for rent may be rented to a user by exchange between the battery pack 141 for rent and a battery pack 141 brought by the user. The battery pack 141 brought by the user may be a battery pack 141 owned by the user or may be a battery pack 141 returned by the user.

The storage unit 142 is an example of a storage of the present disclosure (a storage provided in a first battery pack and a storage provided in a second battery pack) and is a storage unit in which identification information of the battery pack 141 and the like are stored. For example, the storage unit 142 is an IC tag in which the identification information of the battery pack 141 is stored. Examples of the identification information include an ID number, a production date, and a production place of the battery pack 141. Note that identification information of a battery pack is hereinafter sometimes referred to as battery pack identification information.

The storage unit 142 may further store therein information indicative of the state of the battery pack 141. Examples of the information indicative of the state of the battery pack 141 include the amount of charge, designed capacity, learning capacity, internal resistance, temperature, the number of charge discharge cycles (e.g., the number of times of charge, the number of times of discharge), and abnormality history information such as temperature abnormality, electric current abnormality, voltage abnormality, and impact abnormality.

The acquisition unit 151 is an example of a second acquirer of the present disclosure and is an acquisition unit that acquires battery pack identification information from the storage unit 142 of the battery pack 141. For example, the acquisition unit 151 is a tag reader that reads out battery pack identification information from an IC tag.

The connection unit 152 is an example of a connector of the present disclosure and is a connection unit for electrical connection with the battery pack 141. Electric power is supplied to and from the battery pack 141 via the connection unit 152 connected to the battery pack 141.

The discharging unit 153 is an example of a discharger of the present disclosure and is a discharging unit that discharges the battery pack 141 connected to the connection unit 152. That is, the discharging unit 153 discharges the battery pack 141 via the connection unit 152.

The inspection unit 154 is an example of a first inspector of the present disclosure and is an inspection unit that inspects whether or not the battery pack 141 can be discharged. Specifically, the inspection unit 154 inspects whether or not the battery pack 141 can be discharged by the discharging unit 153 in a state in which the battery pack 141 is connected to the connection unit 152. For example, the inspection unit 154 inspects whether or not the battery pack 141 can be discharged by inspecting whether or not a normal electric current value is obtained when the battery pack 141 is discharged by the discharging unit 153.

The charging unit 155 is an example of a charger of the present disclosure and is a charging unit that charges the battery pack 141 connected to the connection unit 152. That is, the charging unit 155 charges the battery pack 141 via the connection unit 152.

The inspection unit 156 is an example of a second inspector of the present disclosure and is an inspection unit that inspects whether or not the battery pack 141 can be charged. Specifically, the inspection unit 156 inspects whether or not the battery pack 141 is charged by the charging unit 155 in a state in which the battery pack 141 is connected to the connection unit 152. For example, the inspection unit 156 inspects whether or not the battery pack 141 is charged by inspecting whether or not a normal electric current value is obtained when the battery pack 141 is charged by the charging unit 155.

The control unit 161 is an example of control circuitry of the present disclosure and is a control unit that controls the rental system. For example, the control unit 161 is not limited to a specific one, provided that the control unit 161 has a control function. The control unit 161 includes a computation unit (not illustrated) and a storage unit (not illustrated) in which a control program is stored. The computation unit is, for example, an MPU or a CPU. The storage unit is, for example, a memory. The control unit 161 may be realized by a single control unit that performs centralized control or may be realized by a plurality of control units that perform decentralized control in cooperation with one another.

Specifically, the control unit 161 associates user identification information acquired by the acquisition unit 121 and battery pack identification information acquired by the acquisition unit 151. Furthermore, the control unit 161 compares information acquired by the acquisition unit 121 and the acquisition unit 151 when the battery pack 141 is returned and information stored in the storage unit 171 when the battery pack 141 is rented. Note that in a case where a plurality of battery packs are rented to a user, it is possible that pieces of identification information obtained by adding different pieces of identification information to identification information of the user be used as the identification information of the user, and these pieces of identification information be associated with pieces of identification information of the respective battery packs.

The storage unit 171 is an example of a storage included in the rental system of the present disclosure and is a storage unit in which identification information of a user and identification information of the battery pack 141 are stored in association with each other when the battery pack 141 is rented to the user. For example, the storage unit 171 is a storage unit in an information processing device.

The storage unit 171 may further store therein information indicative of the degree of degradation of the battery pack 141. The storage unit 171 may further store therein identification information of a user and identification information of the battery pack 141 in association with each other in a case where the battery pack 141 is a user's possession brought by the user.

The storage unit 171 may physically include a plurality of storage elements. That is, the storage unit 171 may physically include a plurality of storage units. For example, the storage unit 171 may include (i) a storage unit in which identification information of a user and identification information of the battery pack 141 rented to the user are stored in association with each other, (ii) a storage unit in which information indicative of the degree of degradation of the battery pack 141 is stored, and (iii) a storage unit in which identification information of a user and identification information of the battery pack 141 owned by the user are stored in association with each other.

The output unit 181 is an example of an output unit of the present disclosure and is an output unit that acquires information indicative of the degree of degradation stored in the storage unit 171 and then outputs the acquired information indicative of the degree of degradation. For example, the output unit 181 is an output unit in an information processing device. The output unit 181 may output information indicative of the degree of degradation on a display screen. The display screen may be included in the output unit 181. Alternatively, the output unit 181 may output information indicative of the degree of degradation on a display screen provided outside the output unit 181.

The notification unit 182 is an example of a notifier of the present disclosure and is a notification unit that notifies a user of completion of charge. For example, in a case where the battery pack 141 is a user's possession, the notification unit 182 notifies the user of completion of charge at the time of completion of charge of the battery pack 141. The notification unit 182 may notify the user of completion of charge by using an information terminal of the user through communication or may notify the user of completion of charge by using a speaker, an LED (light emitting diode), or the like.

For example, the acquisition unit 121 acquires identification information of a user from the storage device 111. The acquisition unit 151 acquires identification information of the battery pack 141 from the storage unit 142 of the battery pack 141. Then, when the battery pack 141 is rented to the user, the control unit 161 causes the identification information acquired by the acquisition unit 121 and the identification information acquired by the acquisition unit 151 to be stored in the storage unit 171 in association with each other. This allows the rental system to properly manage the user and the battery pack 141 rented to the user in association with each other.

Furthermore, for example, the acquisition unit 151 acquires information indicative of the degree of degradation of the battery pack 141. Then, the control unit 161 causes the information indicative of the degree of degradation acquired by the acquisition unit 151 to be stored in the storage unit 171. This allows the rental system to properly manage the degree of degradation of the battery pack 141.

Furthermore, for example, when the battery pack 141 is rented to the user, the output unit 181 acquires information indicative of the degree of degradation from the storage unit 171 and then outputs the acquired information indicative of the degree of degradation. This allows the rental system to notify a user of information indicative of the degree of degradation when the battery pack 141 is rented to the user.

Furthermore, for example, the output unit 181 outputs the acquired information indicative of the degree of degradation on a display screen. This allows the rental system to visually notify a user of the degree of degradation of the battery pack 141 when the battery pack 141 is rented to the user.

Furthermore, for example, the acquisition unit 151 acquires identification information of the battery pack 141 from the storage unit 142 of the battery pack 141 owned by the user. The control unit 161 causes the identification information of the user and the identification information of the battery pack 141 owned by the user to be stored in the storage unit 171 in association with each other when the battery pack 141 for rent is rented to the user by exchange between the battery pack 141 for rent and the battery pack 141 owned by the user. This allows the rental system to properly manage a user and the battery pack 141 owned by the user in association with each other.

Furthermore, for example, the notification unit 182 notifies the user of completion of charge upon completion of charge of the battery pack 141 owned by the user. Specifically, the notification unit 182 may notify the user of completion of charge by using an information terminal of the user. This allows the rental system to notify a user of a timing appropriate for reception of the battery pack 141 owned by the user.

Furthermore, for example, the control unit 161 compares identification information acquired by the acquisition unit 121 and the acquisition unit 151 with identification information stored in the storage unit 171 when the battery pack 141 is returned from the user. This allows the rental system to confirm that the battery pack 141 rented to a user is the same as the battery pack 141 returned from the user.

Furthermore, for example, the control unit 161 performs penalty processing for imposing a penalty on the user in a case where the user returns the battery pack 141 past a return deadline. This allows the rental system to impose a penalty on a user in accordance with an excess period after the return deadline of the battery pack 141.

Furthermore, for example, it is determined that the degree of degradation at the time of return of the battery pack 141 from the user is higher by a predetermined value than the degree of degradation at the time of rent of the battery pack 141 to the user on the basis of information, acquired by the acquisition unit 151, indicative of the degree of degradation at the time of return of the battery pack 141 from the user and information, stored in the storage unit 171, indicative of the degree of degradation at the time of rent of the battery pack 141 to the user, the control unit 161 performs penalty processing for imposing a penalty on the user. This allows the rental system to impose a penalty in accordance with excessive degradation of the battery pack 141 returned from a user. Note that the predetermined value is set to any value by those who rent the battery pack 141.

Furthermore, for example, the acquisition unit 151 acquires information indicative of the state of the battery pack 141 when the battery pack 141 is returned from the user. Examples of the information indicative of the state of the battery pack 141 include the amount of charge, voltage, temperature, the number of charge discharge cycles, and abnormality history information such as temperature abnormality, electric current abnormality, voltage abnormality, and impact abnormality.

In a case where it is determined that the battery pack 141 has abnormality in accordance with the information indicative of the state of the battery pack 141, the control unit 161 performs penalty processing for imposing a penalty on the user. This allows the rental system to impose a penalty in accordance with abnormality of the battery pack 141 returned from a user.

Furthermore, for example, the acquisition unit 151 acquires information indicative of the degree of degradation of the battery pack 141 brought by the user. When the battery pack 141 for rent is rented to the user by exchange between the battery pack 141 for rent and the battery pack 141 brought by the user, the control unit 161 selects the battery pack 141 to be rented to the user from a plurality of battery packs 141 for rent. In this case, the control unit 161 selects, as the battery pack 141 to be rented to the user, a battery pack 141 whose degree of degradation is equal to or lower than that of the battery pack 141 brought by the user.

This allows the rental system to select, as a battery pack 141 to be rented to a user, a battery pack 141 that has quality equivalent to or greater than a battery pack 141 brought by the user.

Furthermore, for example, the connection unit 152 is electrically connected to the battery pack 141. The discharging unit 153 discharges the battery pack 141 connected to the connection unit 152. The connection unit 152 is integral with the acquisition unit 151. The acquisition unit 151 is located so as to be able to acquire battery pack identification information from the storage unit 142 provided in the battery pack 141 in a state where the battery pack 141 and the connection unit 152 are connected. Specifically, in a case where the acquisition unit 151 acquires battery pack identification information through wired communication, the acquisition unit 151 is a communication terminal, and the communication terminal is located so as to be connectable to a communication terminal on the battery pack 141 side in a state in which the battery pack 141 is connected to the connection unit 152. In a case where the acquisition unit 151 acquires battery pack identification information through wireless communication, the acquisition unit 151 is a wireless communication unit, and the wireless communication unit is located so as to be communicable with a wireless communication unit on the battery pack 141 side in a state in which the battery pack 141 is connected to the connection unit 152. Note that the state in which the wireless communication unit is located so as to be communicable with a wireless communication unit on the battery pack 141 side refers to a state where the wireless communication unit is located within a communication range of the wireless communication unit on the battery pack 141 side.

This allows the rental system to acquire identification information of the battery pack 141 while discharging the battery pack 141.

Furthermore, for example, the inspection unit 154 inspects whether or not the battery pack 141 is discharged by using the discharging unit 153 in a state in which the battery pack 141 and the discharging unit 153 are electrically connected to each other via the connection unit 152. This allows the rental system to inspect whether or not the battery pack 141 is properly discharged at the time of rent and/or at the time of return.

Furthermore, for example, the charging unit 155 charges the battery pack 141 connected to the connection unit 152. The inspection unit 156 inspects whether or not the battery pack 141 is charged by using the charging unit 155 in a state in which the battery pack 141 and the charging unit 155 are electrically connected to each other via the connection unit 152. This allows the rental system to inspect whether or not the battery pack 141 is properly charged at the time of rent and/or at the time of return.

Furthermore, for example, the housing 131 contains a plurality of battery packs 141. The connection unit 152 is provided in the housing 131 and is electrically connected to each of the plurality of battery packs 141. The charging unit 155 charges the plurality of battery packs 141 connected to the connection unit 152 by using electric power from an external power supply. The acquisition unit 151 is located so as to be able to acquire identification information of each of the plurality of battery packs 141 from a plurality of storage units 142 of the plurality of battery packs 141 connected to the connection unit 152 in the housing 131.

This allows the rental system to acquire identification information of each of the plurality of battery packs 141 while charging the plurality of battery packs 141 in the housing 131 in which the plurality of battery packs 141 are contained.

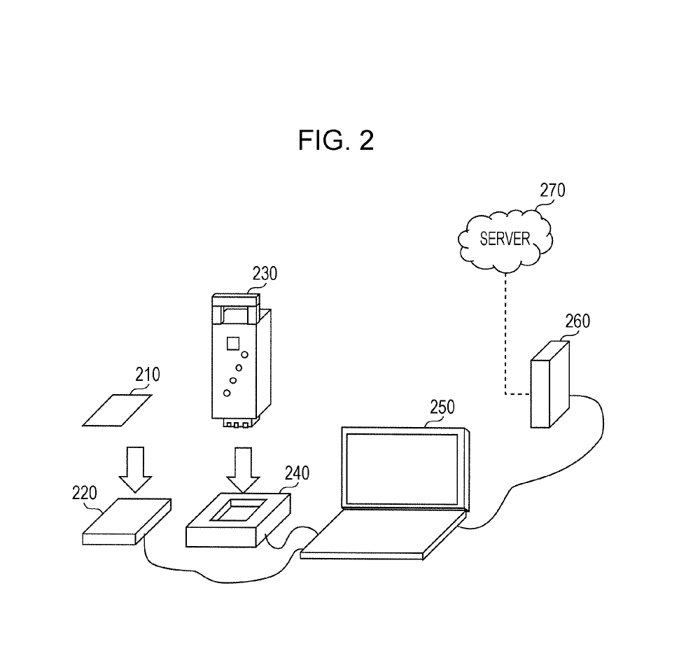

FIG. 2 is a schematic view illustrating a first example of application of the rental system illustrated in FIG. 1. FIG. 2 illustrates a membership card 210, a card reader 220, a battery pack 230, an inspection device 240, a processing device 250, a router 260, and a server device 270.

The membership card 210 corresponds to the storage device 111 in FIG. 1. User identification information for identifying a user who is a member of a rental service is stored in the membership card 210. The membership card 210 is given to the user by a business operator that operates the rental service when the user is registered as a member. Note that the user identification information is hereinafter sometimes referred to as a member ID.

The card reader 220 corresponds to the acquisition unit 121 in FIG. 1. The card reader 220 acquires the member ID by reading out the member ID from the membership card 210.

The battery pack 230 corresponds to the battery pack 141 in FIG. 1. The battery pack 230 is a battery pack that can be charged and discharged. The battery pack 230 includes a storage unit that corresponds to the storage unit 142 in FIG. 1. Identification information of the battery pack 230 (battery pack identification information) is stored in the storage unit of the battery pack 230. Furthermore, the number of times of charge, the number of times of discharge, internal resistance, learning capacity, and the like of the battery pack 230 may be stored in the storage unit of the battery pack 230.

Note that the battery pack identification information is hereinafter sometimes referred to as a battery pack ID.

The inspection device 240 corresponds to the acquisition unit 151, the connection unit 152, the discharging unit 153, the charging unit 155, and the inspection units 154 and 156 in FIG. 1. In the inspection device 240, the connection unit 152 and the acquisition unit 151 may be integral with each other, and the acquisition unit 151 may be located so as to be able to acquire battery pack identification information from the storage unit 142 provided in the battery pack 141 in a state in which the battery pack 141 and the connection unit 152 are connected. For example, the inspection device 240 acquires battery pack identification information from the storage unit of the battery pack 230. In addition, the inspection device 240 plays similar roles to the connection unit 152, the discharging unit 153, the charging unit 155, and the inspection units 154 and 156 in FIG. 1.

The inspection device 240 is electrically connected to the battery pack 230. The inspection device 240 may inspect whether or not the battery pack 230 is discharged. The inspection device 240 may inspect whether or not the battery pack 230 is charged.

The processing device 250 corresponds to the control unit 161, the output unit 181, and the notification unit 182 in FIG. 1. For example, the processing device 250 includes the control unit 161, the output unit 181, and the notification unit 182 in FIG. 1. The processing device 250 may be a personal computer that processes information. For example, the processing device 250 associates the member ID acquired by the card reader 220 and the battery pack ID acquired by the inspection device 240. In addition, the processing device 250 plays similar roles to the control unit 161, the output unit 181, and the notification unit 182 in FIG. 1.

The router 260 is a communication device that relays communication between the processing device 250 and the server device 270. More specifically, the router 260 is a relay device that allows the processing device 250 to communicate with the server device 270 via the Internet.

The server device 270 corresponds to the storage unit 171 in FIG. 1. For example, the server device 270 includes the storage unit 171. Furthermore, the server device 270 may include one or more server devices and may constitute a cloud system. In the present embodiment, the server device 270 and the processing device 250 are connected to each other via the Internet.

For example, a member ID and a battery pack ID are stored in association with each other in the server device 270. In addition, the server device 270 plays a similar role to the storage unit 171 in FIG. 1. Note that the processing device 250 may further include a storage unit (not illustrated) in which a member ID and a battery pack ID are stored in association with each other not only in a case where the member ID and the battery pack ID are not managed in the server device 270, but also in a case where the member ID and the battery pack ID are stored in association with each other in the server device 270 as described above.

As described above, the membership card 210 is given to a user by a business operator when the user is registered as a member of the rental service. The business operator receives the membership card 210 given to the user when the battery pack 230 is rented to the user. Then, the member ID acquired from the membership card 210 and the battery pack ID acquired from the battery pack 230 are associated with each other in the rental system.

Specifically, when the battery pack 230 is rented to the user, the card reader 220 reads out the member ID from the membership card 210, and the inspection device 240 reads out the battery pack ID from the battery pack 230 rented to the user in the rental system. The processing device 250 causes the member ID read out by the card reader 220 and the battery pack ID read out by the inspection device 240 to be registered in association with each other in the server device 270. Then, the business operator rents the battery pack 230 to the user and returns the membership card 210 to the user.

This allows the user and the battery pack 230 rented to the user to be properly managed in association with each other.

Note that the degree of degradation of the battery pack 230 rented to the user may be managed. For example, use history information is stored in the storage unit of the battery pack 230. The use history information is an example of information indicative of the degree of degradation of the battery pack 230. That is, the use history information corresponds to the information indicative of the degree of degradation of the battery pack 230. The degree of degradation will be described later.

The inspection device 240 acquires information indicative of the degree of degradation of the battery pack 230 by acquiring the use history information from the storage unit of the battery pack 230 rented to the user. The processing device 250 causes the information indicative of the degree of degradation acquired by the inspection device 240 to be registered in the server device 270. This allows the degree of degradation of the battery pack 230 rented to the user to be managed. The user may be notified of the degree of degradation by using a display screen of the processing device 250 or the like.

The use history information may include history information indicative of the state of the battery pack 230. In the battery pack 230, the use history information may be stored in the storage unit in which the battery pack ID is stored or may be stored in a storage unit different from the storage unit in which the battery pack ID is stored.

Next, when the user returns the battery pack 230 to the business operator, the user hands over the membership card 210 and the battery pack 230 to the business operator. Then, in the rental system, the member ID acquired from the membership card 210 and the battery pack ID acquired from the battery pack 230 are compared with the member ID and the battery pack ID registered in association with each other in the server device 270.

Specifically, the card reader 220 reads out the member ID from the membership card 210 of the user, and the inspection device 240 reads out the battery pack ID from the returned battery pack 230. The processing device 250 compares the member ID read out by the card reader 220 and the battery pack ID read out by the inspection device 240 with the member ID and the battery pack ID registered in association with each other in the server device 270.

In a case where the member ID thus read out matches the registered member ID and where the battery pack ID thus read out matches the registered battery pack ID, the business operator receives the battery pack 230 and hands over the membership card 210 to the user. This makes it possible to properly confirm that the battery pack 230 rented to the user is the same as the battery pack 230 returned by the user when the battery pack 230 is returned.

Note that in a case where the member ID read out by the card reader 220 and the battery pack ID read out by the inspection device 240 do not match the member ID and the battery pack ID registered in the server device 270 when the battery pack 230 is returned, return of the battery pack 230 may be refused.

In a case where the battery pack 230 is returned past a predetermined return deadline, a penalty may be imposed on the user in accordance with an excess period.

The quality of the battery pack 230 may be inspected when the battery pack 230 is returned. For example, the inspection device 240 acquires information indicative of the degree of degradation of the battery pack 230 by acquiring the use history information from the storage unit of the returned battery pack 230.

In a case where the degree of degradation of the returned battery pack 230 is excessively higher than the degree of degradation registered in the server device 270 at the time of rent, i.e., in a case where degradation has excessively progressed, the user may be notified of information indicative of the excessive progress of degradation by using the processing device 250, and a penalty may be imposed on the user in accordance with the progress of degradation.

Furthermore, abnormality of the battery pack 230 may be inspected when the battery pack 230 is returned. For example, the use history information stored in the storage unit of the battery pack 230 sometimes indicates abnormality such as a rise in temperature in the battery pack 230 or shake caused by drop.

In view of this, the processing device 250 causes the inspection device 240 to acquire the use history information of the battery pack 230 and determines whether or not the battery pack 230 has abnormality on the basis of the use history information. In a case where the battery pack 230 has abnormality, the processing device 250 may notify the user of information indicative of the abnormality and may impose a penalty on the user in accordance with the degree (level) of the abnormality. In a case where the battery pack 230 has severe abnormality, the battery pack 230 is abandoned.

In a case where a penalty is imposed on the user, the processing device 250 performs penalty processing for imposing a penalty on the user. The penalty processing is information processing such as processing for calculating a higher billing amount than usual for rent of a battery pack, processing for associating information for restricting new rent with a member ID, or processing for reducing the number of points for discounting that can be used in the rental service. Note that the term “usual” refers to a case where no penalty is imposed on a user.

The processing device 250 may transmit results of the quality inspection and the abnormality inspection to the server device 270. The server device 270 may store therein the results of the quality inspection and the abnormality inspection. For example, in a case where it is determined as a result of the abnormality inspection that the returned battery pack 230 has severe abnormality, the battery pack 230 is abandoned.

The inspection device 240 may inspect charge and discharge of the battery pack 230 rented to the user. Furthermore, the inspection device 240 may inspect charge and discharge of the battery pack 230 returned from the user. The inspection device 240 may inspect one of charge and discharge. It is assumed that the level of charge at the time of rent is high, and the level of charge at the time of return is low. In view of this, the inspection device 240 may inspect discharge at the time of rent and inspect charge at the time of rent.

Another battery pack may be rented to the user from the business operator after the battery pack 230 is returned. For example, the discharged battery pack 230 may be returned from the user to the business operator, and another charged battery pack may be rented to the user by the business operator. The following describes this example.

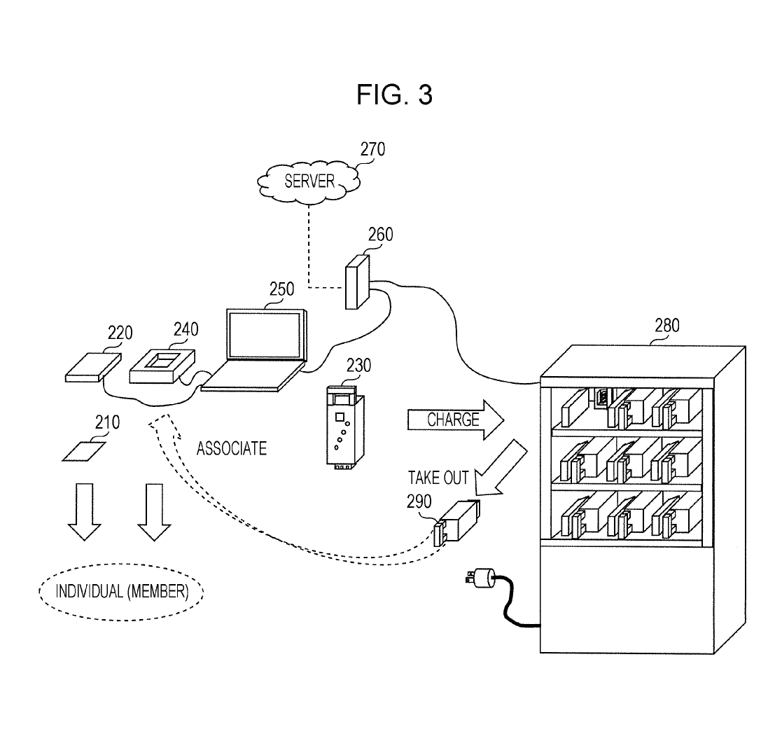

FIG. 3 is a schematic view illustrating a second example of application of the rental system illustrated in FIG. 1. FIG. 3 further illustrates a charging locker 280 and a battery pack 290.

The charging locker 280 corresponds to the housing 131 in FIG. 1. The charging locker 280 contains a plurality of battery packs. The charging locker 280 plays similar roles to the connection unit 152 and the charging unit 155 in FIG. 1. That is, the charging locker 280 can charge the plurality of battery packs contained in the charging locker 280 by using an external power supply.

For example, the battery pack 230 returned from the user is put into the charging locker 280. Then, the charging locker 280 charges the battery pack 230 contained in the charging locker 280 by using the external power supply.

The battery pack 290 is a battery pack that is newly rented to the user instead of the battery pack 230. The battery pack 290 is taken out from the charging locker 280 and placed on the inspection device 240 before the battery pack 290 is rented to the user. Then, the processing device 250 causes the member ID acquired from the membership card 210 by the card reader 220 and a battery pack ID acquired from the battery pack 290 by the inspection device 240 to be newly registered in association with each other in the server device 270.

This allows the user and the battery pack 290 newly rented to the user to be properly managed in association with each other.

For example, the processing device 250 selects, as the newly rented battery pack 290, a fully charged battery pack whose degree of degradation is lower than the returned battery pack 230 from among the plurality of battery packs contained in the charging locker 280. The processing device 250 notifies the charging locker 280 of the selected battery pack 290 through communication. The charging locker 280 indicates the selected battery pack 290 by using an LED or the like. The charging locker 280 may unlock the battery pack 290 so that the battery pack 290 can be taken out.

The battery pack 290 selected and taken out by the above operation may be rented to the user. This allows the battery pack 290 whose quality is equivalent to or greater than the battery pack 230 to be rented to the user. Therefore, the user can use the rented battery pack 290 as if the user continues to use the battery pack 230. Furthermore, since a battery pack having the best quality among the plurality of battery packs need not be rented to the user, each of the plurality of battery packs is effectively used in accordance with the quality thereof.

The charging locker 280 may play a similar role to the inspection device 240. That is, the charging locker 280 may further play similar roles to the acquisition unit 151, the discharging unit 153, and the inspection units 154 and 156 in FIG. 1. For example, the charging locker 280 may acquire a battery pack ID of each of the plurality of battery packs, charge and discharge each of the plurality of battery packs, and inspect the quality of each of the plurality of battery packs. In this case, the inspection device 240 need not be included in the rental system.

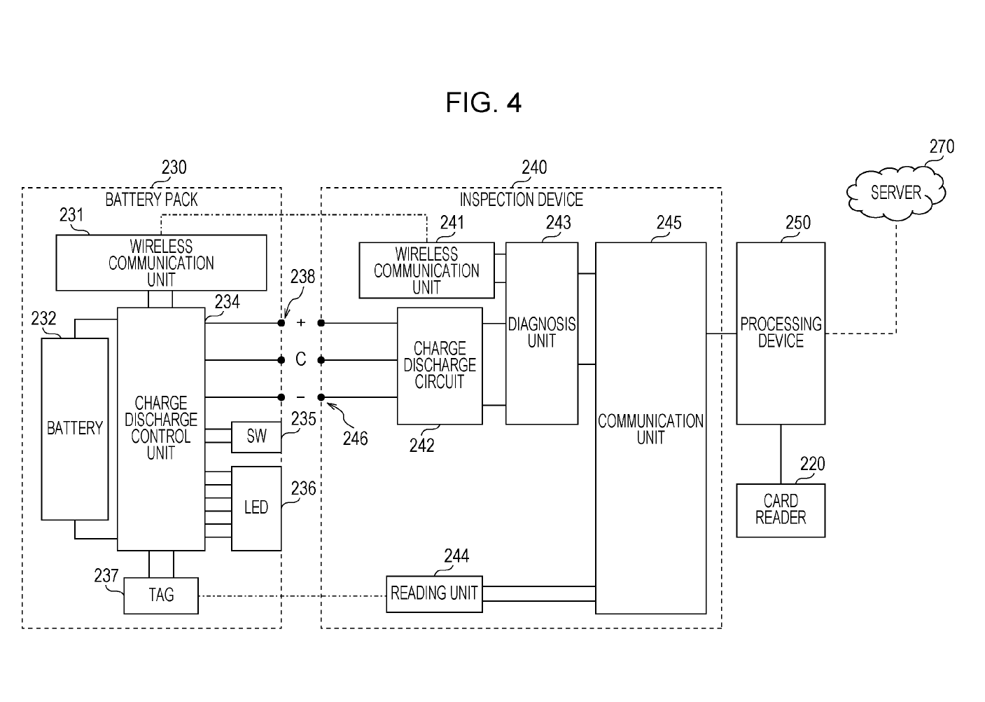

FIG. 4 is a block diagram illustrating configurations of the inspection device 240 and the like illustrated in FIG. 2. The battery pack 230 illustrated in FIG. 4 includes a wireless communication unit 231, a battery 232, a charge discharge control circuit 234, a switch 235, an LED 236, a tag 237, and a connection unit 238.

The wireless communication unit 231 is a communication unit for wirelessly communication with the inspection device 240. The battery 232 accumulates electric power. The charge discharge control circuit 234 charges the battery 232. Furthermore, the charge discharge control circuit 234 discharges the battery 232. The switch 235 is a switch by which charge and discharge are manually switched.

The LED 236 is an indicator that indicates an operation state, i.e., at least one of charge and discharge. The LED 236 may indicate a state of charge (SOC). The tag 237 is a storage unit in which a battery pack ID is stored. For example, the tag 237 is an IC tag or an NFC tag that is compatible with near field communication (NFC). The connection unit 238 is a connection unit that is electrically connectable to the inspection device 240.

The inspection device 240 includes a wireless communication unit 241, a charge discharge circuit 242, a diagnosis unit 243, a reading unit 244, and a communication unit 245.

The wireless communication unit 241 is a communication unit for wirelessly communication with the battery pack 230 and the like. The charge discharge circuit 242 charges the battery pack 230 and the like. Furthermore, the charge discharge circuit 242 discharges the battery pack 230 and the like. The diagnosis unit 243 inspects the quality and the like of the battery pack 230 by using the wireless communication unit 241 or the charge discharge circuit 242.

The reading unit 244 reads out the battery pack ID from the tag 237. For example, the reading unit 244 is a tag reader that reads out the battery pack ID from the tag 237 through near field communication. The communication unit 245 is a communication unit that communicates with the processing device 250. The connection unit 246 is a connection unit that is electrically connectable to the battery pack 230 and the like.

Since the inspection device 240 includes the constituent elements described above, the inspection device 240 can acquire the battery pack ID, information indicative of the degree of degradation, and the like of the battery pack 230, and transmit these pieces of information to the processing device 250. The inspection device 240 can inspect discharge by discharging the battery pack 230. The inspection device 240 can inspect charge by charging the battery pack 230.

Note that the reading unit 244 is located so as to be able to read out the battery pack ID from the tag 237 through near field communication in a state in which the battery pack 230 and the inspection device 240 are electrically connected to each other.

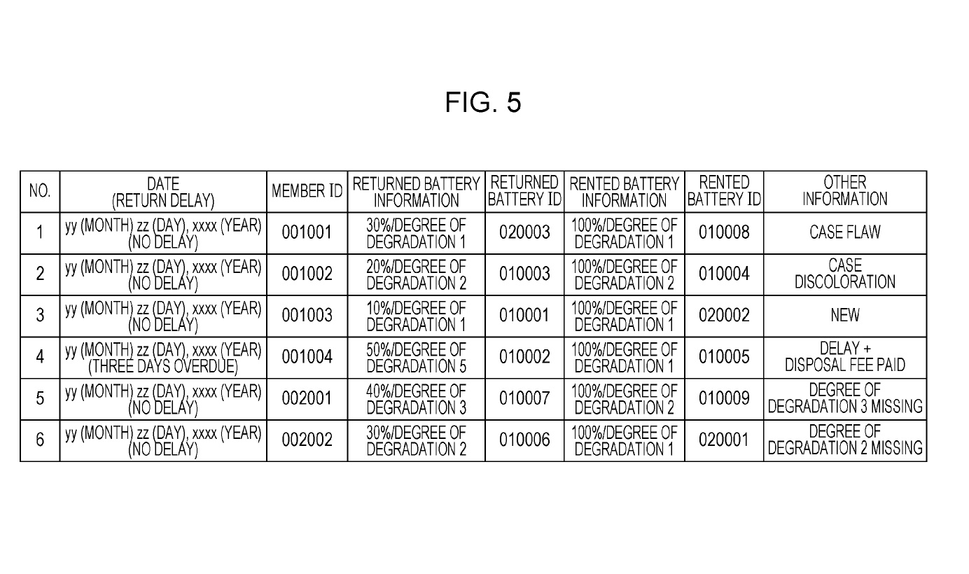

FIG. 5 is a diagram illustrating rent information (exchange information) stored in the server device 270 illustrated in FIG. 2. In the rent information, a registration number, a date (return delay), a member ID, returned battery information, a returned battery ID, rented battery information, a rented battery ID, and other information are associated.

The registration number is a sequence number indicative of the order of registration. The date (return delay) is a date on which a battery pack is returned and another battery pack is rented and indicates a period of delay in a case where return is delayed. The member ID is user identification information for identifying a user.

The returned battery information includes information indicative of a state of charge of a returned battery pack and information indicative of the degree of degradation of the returned battery pack. The returned battery ID is a battery pack ID of the returned battery pack. The rented battery information includes information indicative of a state of charge of a rented battery pack and information indicative of the degree of degradation of the rented battery pack. The rented battery ID is a battery pack ID of the rented battery pack. The other information is other information concerning return or rent of a battery pack.

For example, when a battery pack is returned and another battery pack is newly rented, the processing device 250 checks data registered in the rent information and registers new data in the rent information. Other information included in the rent information may be input by a business operator.

For example, the data of the registration number 4 in the rent information in FIG. 5 indicates that a battery pack whose degree of degradation is 5 has been returned three days overdue and that a battery pack whose degree of degradation is 1 has been newly rented upon payment of a fine for the delay and a disposal fee. For example, the data of the registration number 5 indicates that a battery pack whose degree of degradation is 3 has been returned and that a battery pack whose degree of degradation is 2 has been newly rented because a battery pack whose degree of degradation is 3 that should be newly rented is missing.

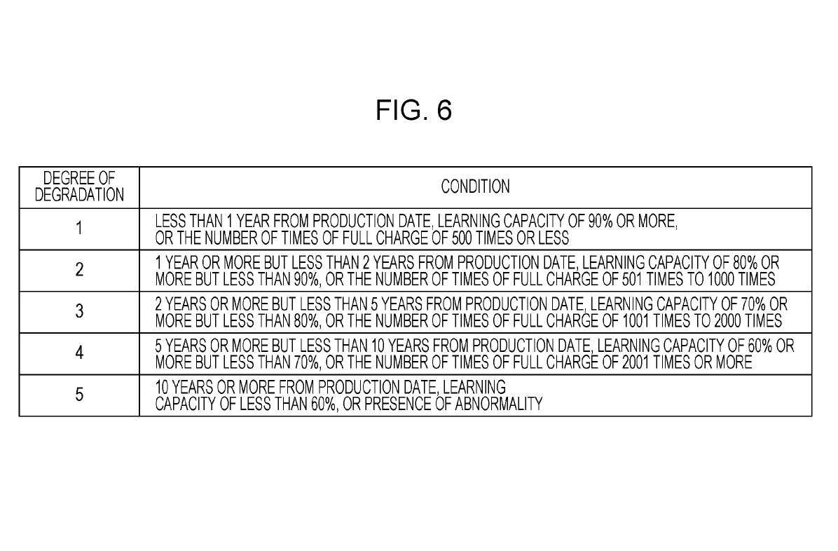

FIG. 6 is a diagram illustrating information indicative of degrees of degradation acquired by the inspection device 240 and the like illustrated in FIG. 2. Each of the degrees of degradation 1 through 5 corresponds to the information indicative of the degree of degradation. In ascending order, the degrees of degradation are classified into the degree of degradation 1, the degree of degradation 2, the degree of degradation 3, the degree of degradation 4, and the degree of degradation 5. That is, the degree of degradation 1 is the lowest degree of degradation, and the degree of degradation 5 is the highest degree of degradation. More advanced degradation means a higher degree of degradation. That is, a higher degree of degradation means lower quality.

In the present embodiment, information indicative of a degree of degradation is defined by any parameters that can define the degree of degradation such as a period elapsed from a production date of a battery pack, internal resistance, learning capacity, the number of times of full charge, and the presence or absence of abnormality. The learning capacity indicates the percentage of the current full charge capacity to the initial full charge capacity of the battery pack. The learning capacity corresponds to a state of health (SOH). The number of times of full charge is the number of times the battery pack reached a full charge state. The presence or absence of abnormality is the presence or absence of abnormality of the battery pack at present and/or in the past. The information indicative of a degree of degradation may be information such as a period elapsed from a production date of a battery pack, internal resistance, learning capacity, the number of times of full charge, and the presence or absence of abnormality or may be a character, a symbol, a numeral, or an indicator value indicative of the degree of degradation defined by this information.

For example, in a case where a battery pack satisfies the condition of the degree of degradation 5, the battery pack is classified into the degree of degradation 5. In a case where a battery pack satisfies the condition of the degree of degradation 4, the battery pack is classified into the degree of degradation 4. In a case where a battery pack satisfies the condition of the degree of degradation 3, the battery pack is classified into the degree of degradation 3. In a case where a battery pack satisfies the condition of the degree of degradation 2, the battery pack is classified into the degree of degradation 2. In a case where a battery pack satisfies the condition of the degree of degradation 1, the battery pack is classified into the degree of degradation 1.

Note that information indicative of a degree of degradation may be defined by any one of the internal resistance, learning capacity, the number of times of full charge, and the presence or absence of abnormality.

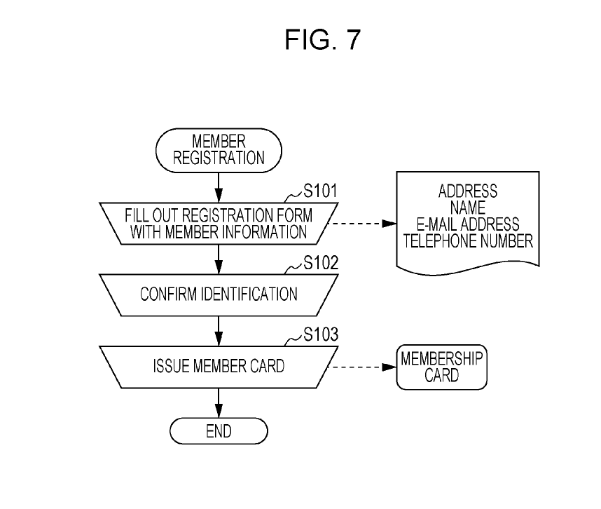

Next, a processing flow of the rental system illustrated, for example, in FIG. 2 is described by using the flow charts of FIGS. 7 through 11.

FIG. 7 is a flow chart illustrating member registration processing related to the rental system illustrated, for example, in FIG. 2. First, a user fills in a registration form with user information (member information) (S101). For example, the user fills in the registration form with an address, a name, an e-mail address, a telephone number, and the like. Next, the user presents identification to the business operator, and the business operator confirms the identification (S102). Then, the business operator issues a membership card 210 in which a member ID is stored (S103).

In this way, the user is registered as a member. Specifically, the processing device 250 causes the member information and the member ID to be registered in association with each other in the server device 270. Note that the issued membership card 210 is given to the user.

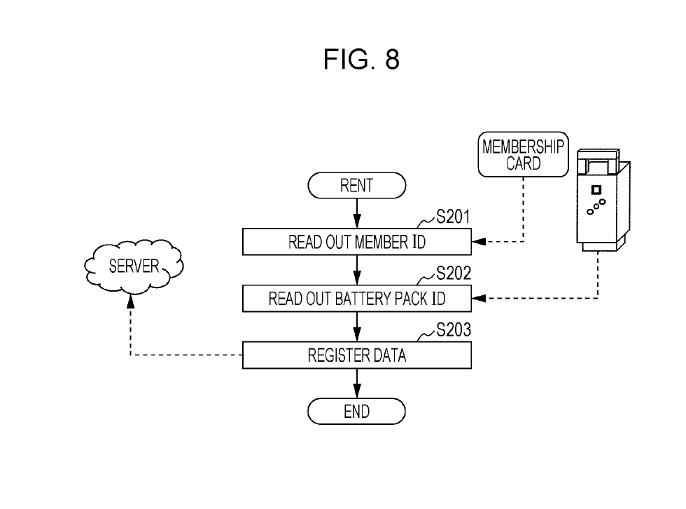

FIG. 8 is a flow chart illustrating rental processing related to the rental system illustrated, for example, in FIG. 2. The user presents the membership card 210 to the business operator when the user uses rental service. Then, in the rental system, the member ID and a battery pack ID of a battery pack 230 to be rented to the user are associated with each other.

Specifically, the card reader 220 reads out the member ID from the membership card 210 (S201). Next, the inspection device 240 reads out the battery pack ID from the battery pack 230 to be rented to the user (S202). Note that in this example, Steps S201 and S202 are executed in this order, but the order is not limited to this. Steps S201 and S202 may be executed in a reverse order.

At this point in time, the processing device 250 may cause the inspection device 240 to inspect charge and discharge of the battery pack 230. Furthermore, the processing device 250 may cause the inspection device 240 to inspect abnormality and quality of the battery pack 230. Furthermore, the processing device 250 may output an inspection result on a display screen in order to notify the user of the inspection result.

Then, the processing device 250 associates the member ID and the battery pack ID with each other. Then, the processing device 250 causes data in which the member ID and the battery pack ID are associated with each other to be registered in the server device 270 (S203). This allows the user and the battery pack 230 to be rented to the user to be properly managed in association with each other. The processing device 250 may cause the inspection result of the battery pack 230 at the time of rent to be registered in the server device 270.

Note that the battery pack 230 that has been fully charged is rented to the user. The battery pack 230 that has been almost fully charged may be rented to the user. For example, the battery pack 230 whose charge level is higher than a predetermined one may be rented to the user.

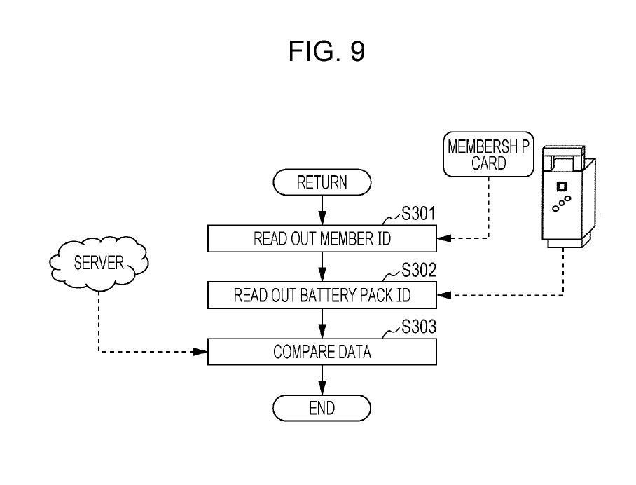

FIG. 9 is a flow chart illustrating return processing related to the rental system illustrated, for example, in FIG. 2. The user presents the membership card 210 to the business operator when the user returns the rented battery pack 230. Then, in the rental system, the member ID and the battery pack ID of the returned battery pack 230 are compared with the member ID and the battery pack ID registered in the server device 270.

Specifically, the card reader 220 reads out the member ID from the membership card 210 (S301). Next, the inspection device 240 reads out the battery pack ID from the battery pack 230 returned from the user (S302). Note that in this example, Steps S301 and S302 are executed in this order, but the order is not limited to this. Steps S301 and S302 may be executed in a reverse order.

Next, the processing device 250 compares the member ID acquired by the card reader 220 and the battery pack ID acquired by the inspection device 240 with the member ID and the battery pack ID registered in the server device 270 (S303).

In a case where the member ID acquired by the card reader 220 and the battery pack ID acquired by the inspection device 240 match the member ID and the battery pack ID registered in the server device 270, the business operator receives the battery pack 230 returned from the user. In this way, it is properly confirmed that the battery pack 230 returned from the user is the same as the battery pack 230 rented to the user when the battery pack 230 is returned.

Note that the processing device 250 may cause the inspection device 240 to inspect charge and discharge of the battery pack 230 at the time of return. Furthermore, the processing device 250 may cause the inspection device 240 to inspect abnormality and quality of the battery pack 230. Furthermore, the processing device 250 may output an inspection result on a display screen in order to notify the user of the inspection result.

In at least one of a case where the user returns the battery pack 230 past a return deadline, a case where the quality has excessively deteriorated, and a case where the returned battery pack 230 has abnormality, a penalty may be imposed on the user.

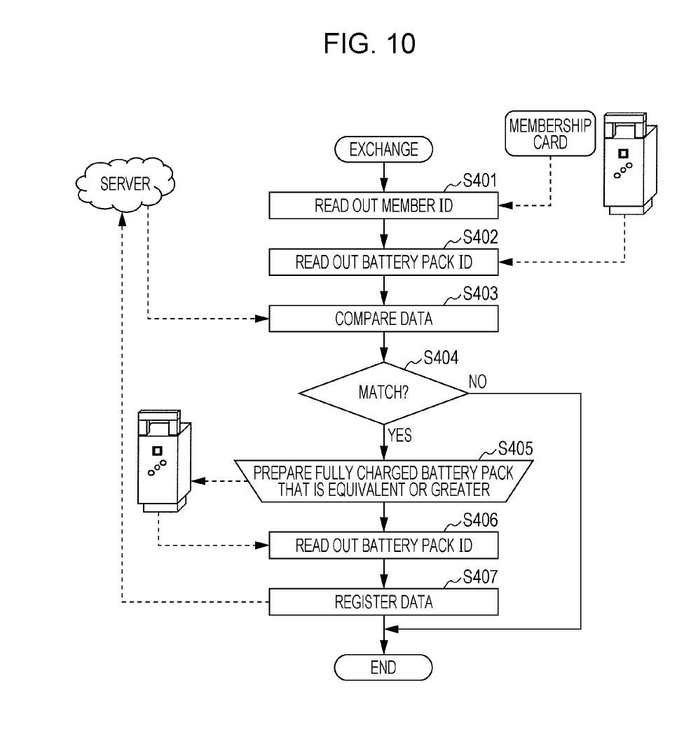

FIG. 10 is a flow chart illustrating exchange processing related to the rental system illustrated, for example, in FIG. 2. When the battery pack 230 is returned from the user, the business operator may newly rent another battery pack 290 to the user. FIG. 10 illustrates operation performed in this case.

First, when the battery pack 230 is returned from the user, the member ID and the battery pack ID of the returned battery pack 230 are compared with the member ID and the battery pack ID registered in the server device 270 in the rental system.

Specifically, the card reader 220 reads out the member ID from the membership card 210 (S401). The inspection device 240 reads out the battery pack ID from the battery pack 230 returned from the user (S402). The processing device 250 compares the member ID acquired by the card reader 220 and the battery pack ID acquired by the inspection device 240 with the member ID and the battery pack ID registered in the server device 270 (S403). In a case where the member ID acquired by the card reader 220 and the battery pack ID acquired by the inspection device 240 match the member ID and the battery pack ID registered in the server device 270 (Yes in S404), return is accepted. Note that in this example, Steps S401 and S402 are executed in this order, but the order is not limited to this. Steps S401 and S402 may be executed in a reverse order.

The above operation is similar to that in the return processing illustrated in FIG. 9. In the exchange processing, next, a battery pack 290 whose quality is equivalent to or greater than the returned battery pack 230 is prepared as a newly rented battery pack (S405).

That is, the newly rented battery pack 290 is a battery pack whose degradation is less advanced than the battery pack 230. The newly rented battery pack 290 is a battery pack that has been charged to such a level that it can be rented. Such a level of charge may be, for example, full charge or may be a level of charge close to full charge. The level of charge close to full charge may be, for example, 90% or higher of full charge.

Next, the inspection device 240 reads out a battery pack ID from the newly rented battery pack 290 (S406). At this point in time, the processing device 250 may cause the inspection device 240 to inspect charge and discharge of the battery pack 290. Furthermore, the processing device 250 may cause the inspection device 240 to inspect abnormality and quality of the battery pack 290. Furthermore, the processing device 250 may output an inspection result on a display screen in order to notify the user of the inspection result.

Then, the processing device 250 associates the member ID and the battery pack ID with each other. Then, the processing device 250 causes data in which the member ID and the battery pack ID are associated with each other to be registered in the server device 270 (S407). This allows the user and the battery pack 290 newly rented to the user to be properly managed in association with each other. The processing device 250 may cause the inspection result of the battery pack 290 at the time of rent to be registered in the server device 270.

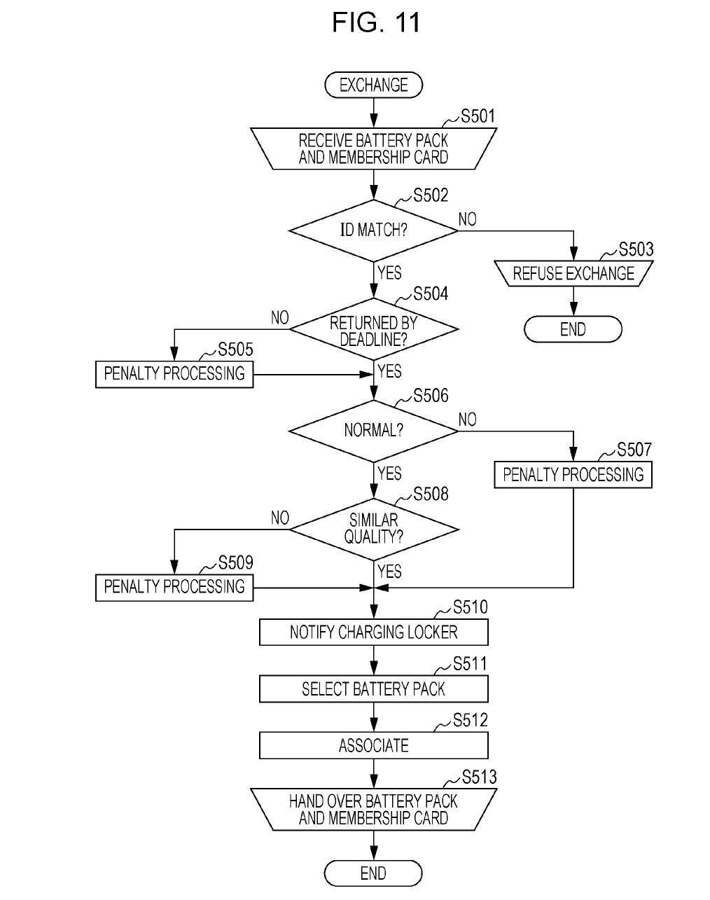

FIG. 11 is a flow chart illustrating a modification of the exchange processing illustrated in FIG. 10. The exchange processing illustrated in FIG. 11 is similar to that illustrated in FIG. 10, but some of the operations are illustrated in detail in FIG. 11.

First, the business operator receives the battery pack 230 and the membership card 210 from the user (S501). Next, the member ID and the battery pack ID are confirmed in the rental system (S502). In a case where the member ID acquired from the membership card 210 and the battery pack ID acquired from the battery pack 230 do not match the member ID and the battery pack ID registered in the server device 270 (No in S502), the business operator refuses exchange (S503).

Meanwhile, in a case where the member ID acquired from the membership card 210 and the battery pack ID acquired from the battery pack 230 match the member ID and the battery pack ID registered in the server device 270 (Yes in S502), it is confirmed whether or not the battery pack 230 has been returned by a return deadline (S504). In a case where the battery pack 230 has been returned past the return deadline (No in S504), the processing device 250 performs penalty processing for imposing a penalty on the user (S505). For example, the processing device 250 calculates, as the penalty processing, a billing amount higher than usual.

Next, the processing device 250 causes the inspection device 240 to check whether or not the battery pack 230 is normal (S506). That is, the processing device 250 causes the inspection device 240 to check whether or not the battery pack 230 has abnormality. In a case where the battery pack 230 is not normal, i.e., in a case where the battery pack 230 has abnormality (No in S506), the processing device 250 performs penalty processing for imposing a penalty on the user such as calculating a billing amount higher than usual (S507). In a case where the battery pack 230 has severe abnormality, the battery pack 230 is abandoned.

Next, the processing device 250 causes the inspection device 240 to check whether or not the battery pack 230 maintains similar quality (S508). In a case where the similar quality is not maintained, i.e., in a case where the quality of the battery pack 230 has excessively deteriorated (No in S508), the processing device 250 performs penalty processing for imposing a penalty on the user such as calculating a billing amount higher than usual (S509).

For example, in a case where the degree of degradation is higher by two or more levels than the degree of degradation registered at the time of rent, the processing device 250 determines that the similar quality is not maintained. In a case where it is determined that the quality of the battery pack 230 has excessively deteriorated and the battery pack 230 cannot be continuously used, the battery pack 230 is abandoned.

Then, the processing device 250 notifies the charging locker 280 of quality information (information indicative of the degree of degradation) and the like (S510). The charging locker 280 selects a battery pack 290 newly rented to the user from among a plurality of battery packs on the basis of the quality information (information indicative of the degree of degradation) (S511).

Specifically, the battery pack 290 selected by the charging locker 280 is a fully charged battery pack whose degree of degradation is the same as that of the returned battery pack 230. For example, in a case where there is no battery pack whose degree of degradation is the same as that of the battery pack 230, a fully charged battery pack whose degree of degradation is lower (degradation is less advanced) than the battery pack 230 may be selected as the battery pack 290.

The charging locker 280 indicates the selected battery pack 290 by using an indicator or the like. Then, the battery pack 290 is taken out and connected to the inspection device 240 by the business operator. The inspection device 240 acquires a battery pack ID of the newly rented battery pack 290. The inspection device 240 may inspect the quality and the like of the battery pack 290.

The processing device 250 causes the member ID acquired by the card reader 220 and the battery pack ID acquired by the inspection device 240 to be registered in the server device 270 in association with each other (S512). For example, the processing device 250 registers data in the rent information illustrated in FIG. 5.

Then, the business operator hands over the battery pack 290 and the membership card 210 to the user (S513). The returned battery pack 230 is put into the charging locker 280 in a case where the returned battery pack 230 can be continuously used. The charging locker 280 charges the battery pack 230 by using an external power supply.

As a result of the above processing, the user and the battery pack 290 newly rented to the user are properly associated with each other.

The battery pack 290 whose quality is equivalent to or greater than the battery pack 230 returned from the user is newly rented. This allows the user to use the battery pack 290 similar to the battery pack 230. That is, the user can use the newly rented battery pack 290 as if the user continues use of the battery pack 230.

The user can use the charged battery pack 290 instead of the discharged battery pack 230. This prevents a problematic situation such as a situation in which the user are unable to use electronic apparatuses while the battery pack 230 is being charged.

Furthermore, in a case where the deteriorated battery pack 290 satisfies a quality condition, the deteriorated battery pack 290 can be rented to the user without giving a sense of discomfort to the user. This allows the rental system to effectively utilize the deteriorated battery pack 290.

Note that a battery pack whose quality is equivalent to or greater than that of a battery pack owned by the user may be rented in exchange with the battery pack owned by the user. For example, a discharged battery pack own by the user is exchanged with a battery pack that has been charged. In this case, the processing device 250 causes the member ID of the user and the battery pack ID of the battery pack owned by the user to be registered in the server device 270.

In this case, the battery pack owned by the user is put into the charging locker 280, and the charging locker 280 charges the battery pack owned by the user. Then, upon completion of charge, the processing device 250 or the charging locker 280 notifies the user of completion of charge through communication. Then, the user returns the battery pack rented to the user and receives the battery pack owned by the user.

This allows the user to use electronic apparatuses by using the rented battery pack while the battery pack owned by the user is being charged. Therefore, the electronic apparatuses can be effectively utilized.

The rental system and the rental management method of the present embodiment may be used bot only by a business operator that provides rental service, but also at a school, an office, and the like. For example, a user may exchange a discharged battery pack and a charged battery pack by using the rental system at a school or an office.

As described above, the rental system and the rental management method of the present embodiment can properly manage a user and a battery pack in association with each other.

Note that in the above embodiment, the constituent elements may be realized by dedicated hardware or may be realized by execution of a software program suitable for the constituent elements. The constituent elements may be realized in a manner such that a program executing unit such as a CPU or a processor reads out and executes a software program recorded on a recording medium such as a hard disc or a semiconductor memory. The software for realizing the rental system of the above embodiment is the following program.

That is, this program causes a computer to execute a rental management method performed by a battery pack rental system including acquiring first identification information, which is identification information of a user, from a storage device in which the first identification information is stored; acquiring second identification information, which is identification information of a first battery pack, which is a battery pack for rent, from a storage unit provided in the first battery pack; and causing the acquired first identification information and the acquired second identification information to be stored in a storage unit of the rental system when the first battery pack is rented to the user.

The constituent elements of the rental system may be circuits. These circuits may constitute a single circuit as a whole or may be separate circuits. These circuits may be general-purpose circuits or may be dedicated circuits.

The rental system according to one or more aspects has been described above on the basis of the embodiment, but the present disclosure is not limited to the embodiment. Various modifications of the present embodiment which a skilled person think of and combinations of constituent elements in different embodiments may be encompassed within the scope of the one or more aspects, as long as such modifications and combinations are not deviated from the purpose of the present disclosure.

For example, in the above embodiment, processing performed by a specific constituent element may be performed by another constituent element instead of the specific constituent element. The order of a plurality of processes may be changed, and the plurality of processes may be performed in parallel.

The present disclosure can be used for a battery pack rental system and is applicable to a charge stand, a factory, a store, a school facility, and the like.

What is claimed is:

1. A rental system comprising:
a first acquirer that acquires first identification information, which is identification information of a user, from a storage device in which the first identification information is stored;
a second acquirer that acquires second identification information, which is identification information of a first battery pack, which is a battery pack for rent, from a storage provided in the first battery pack;
control circuitry that associates the first identification information acquired by the first acquirer and the second identification information acquired by the second acquirer with each other when the first battery pack is rented to the user; and
a storage in which the first identification information and the second identification information are stored in association with each other.

2. The rental system according to claim 1, wherein:
the second acquirer further acquires information indicative of a first degree of degradation, which is a degree of degradation of the first battery pack; and
the information indicative of the first degree of degradation acquired by the second acquirer is further stored in the storage included in the rental system.

3. The rental system according to claim 2, further comprising an output unit that acquires the information indicative of the first degree of degradation from the storage included in the rental system and outputs the information indicative of the first degree of degradation when the first battery pack is rented to the user.

4. The rental system according to claim 3, wherein
the output unit outputs the information indicative of the first degree of degradation on a display screen.

5. The rental system according to claim 1, wherein:
the second acquirer further acquires third identification information, which is identification information of a second battery pack, which is a battery pack owned by the user, from a storage provided in the second battery pack;
the control circuitry further associates the first identification information acquired by the first acquirer and the third identification information acquired by the second acquirer with each other when the first battery pack is rented to the user by exchange between the first battery pack and the second battery pack; and
the first identification information and the third identification information are further stored in association with each other in the storage included in the rental system.

6. The rental system according to claim 5, further comprising a notifier that notifies the user of completion of charge upon completion of charge of the second battery pack.

7. The rental system according to claim 1, wherein
when the first battery pack is returned from the user, the control circuitry compares the first identification information acquired by the first acquirer and the second identification information acquired by the second acquirer with the first identification information and the second identification information that are associated with each other by the control circuitry and stored in the storage included in the rental system when the first battery pack is rented to the user.

8. The rental system according to claim 1, wherein
the control circuitry performs processing for imposing a penalty on the user in a case where the first battery pack is returned from the user past a return deadline.

9. The rental system according to claim 2, wherein
the control circuitry performs processing for imposing a penalty on the user in a case where it is determined that the first degree of degradation acquired when the first battery pack is returned from the user is higher by a predetermined value than that acquired when the first battery pack is rented to the user on the basis of the information indicative of the first degree of degradation acquired by the second acquirer when the first battery pack is returned from the user and the information indicative of the first degree of degradation stored in the storage included in the rental system when the first battery pack is rented to the user.

10. The rental system according to claim 1, wherein
the second acquirer further acquires information indicative of a state of the first battery pack when the first battery pack is returned from the user; and
the control circuitry performs processing for imposing a penalty on the user in a case where it is determined that the first battery pack has abnormality in accordance with the information indicative of the state of the first battery pack.

11. The rental system according to claim 2, wherein
the second acquirer further acquires information indicative of a second degree of degradation, which is a degree of degradation of a second battery pack, which is a battery pack brought by the user; and
the control circuitry selects, as the first battery pack rented to the user, a battery pack whose degree of degradation is equal to or lower than the second degree of degradation from among a plurality of battery packs for rent when the first battery pack is rented to the user by exchange between the first battery pack and the second battery pack.

12. The rental system according to claim 1, further comprising:
a connector that is electrically connected to the first battery pack; and
a discharger that discharges the first battery pack connected to the connector,
the connector being integral with the second acquirer, and
the second acquirer being located so as to be able to acquire the second identification information from the storage provided in the first battery pack when the first battery pack and the connector are connected to each other.

13. The rental system according to claim 12, further comprising a first inspector that inspects whether or not the first battery pack is discharged by using the discharger when the first battery pack and the discharger are electrically connected to each other via the connector.

14. The rental system according to claim 13, further comprising:
a charger that charges the first battery pack connected to the connector; and
a second inspector that inspects whether or not the first battery pack is charged by using the charger when the first battery pack and the charger are electrically connected to each other via the connector.

15. The rental system according to claim 1, further comprising:
a housing in which a plurality of battery packs including the first battery pack are contained;
a connector that is provided in the housing and is electrically connected to each of the plurality of battery packs; and
a charger that charges the plurality of battery packs connected to the connector by using electric power from an external power supply;
the second acquirer being located so as to be able to acquire identification information of each of the plurality of battery packs from a plurality of storages provided in the plurality of battery packs connected to the connector in the housing.

16. A rental management method performed by a rental system, comprising:
acquiring first identification information, which is identification information of a user, from a storage device in which the first identification information is stored;
acquiring second identification information, which is identification information of a first battery pack, which is a battery pack for rent, from a storage provided in the first battery pack; and
causing the acquired first identification information and the acquired second identification information to be stored in a storage included in the rental system when the first battery pack is rented to the user.
